(19) United States
(12) Patent Application Publication
(10) Pub. No.: US 2025/0091497 A1
(43) Pub. Date: Mar. 20, 2025

(54) SEAT CABLE MODULE

(71) Applicant: HI-LEX Corporation, Hyogo (JP)

(72) Inventor: Tomoyoshi OKADA, Hyogo (JP)

(73) Assignee: HI-LEX Corporation, Hyogo (JP)

(21) Appl. No.: 18/827,911

(22) Filed: Sep. 9, 2024

(30) Foreign Application Priority Data
Sep. 15, 2023 (JP) 2023-150216

(51) Int. Cl. B60N 2/90; B60N 2/20

(52) U.S. Cl. CPC B60N 2/929; B60N 2/20

(57) ABSTRACT

A seat cable module includes: a joint piece that fixes an end portion of the first cable and an end portion of the second cable, pulls the second cable by moving by a tensile force, and transmits the tensile force to the second cable; and a module plate in which a housing portion is formed, the housing portion movably housing the joint piece in a direction in which the tensile force acts, and the housing portion opens so as to be capable of housing the joint piece in a direction perpendicular to a surface of the module plate.

### CROSS REFERENCE TO RELATED APPLICATIONS

This application is a Paris Convention, which claims the benefit of priority of Japanese Patent Application No. 2023-150216 filed on Sep. 15, 2023. The contents of the above application is all incorporated by reference as if fully set forth herein in its entirety.

### TECHNICAL FIELD

The present invention relates to a seat cable module.

### BACKGROUND ART

A seat cable module that operates a vehicle seat using a cable has been sometimes used. For example, Patent Literature (hereinafter, referred to as PTL) 1 discloses a seat cable module that operates a reclining device provided in a seat using a plurality of cables.

In this seat cable module, a plurality of cables is connected by a joint piece, and the joint piece is housed in a joint case. Then, the joint case is attached to the main body of the seat cable module.

### CITATION LIST

### Patent Literature

PTL 1
Japanese Patent Application Laid-Open No. 2023-016228

### SUMMARY OF INVENTION

### Technical Problem

However, in the conventional seat cable module, when attaching the joint case to the main body, it is necessary to laterally move the joint case from the central side of the main body and engage the joint case with a claw portion provided at the end portion of the main body.

Therefore, a space needs to be provided in the center of the main body so as not to block the movement of the joint case or cables, which makes it difficult to miniaturize the seat cable module.

The present invention is to solve this problem, and an object of the present invention is to provide a seat cable module that can be miniaturized.

### Solution to Problem

In order to achieve the above object, a seat cable module according to the present invention is a seat cable module for operating a seat by transmitting a tensile force with respect to a first cable to a second cable, and includes: a joint piece that fixes an end portion of the first cable and an end portion of the second cable, pulls the second cable by moving by the tensile force, and transmits the tensile force to the second cable; and a module plate in which a housing portion is formed, the housing portion movably housing the joint piece in a direction in which the tensile force acts, and the housing portion opens so as to be capable of housing the joint piece in a direction perpendicular to a surface of the module plate.

### Advantageous Effects of Invention

According to the present disclosure, the seat cable module can be miniaturized.

### BRIEF DESCRIPTION OF DRAWINGS

FIG. 1 is a front view of a module plate according to an embodiment of the present invention;

FIG. 2 is a perspective view of the module plate according to the embodiment of the present invention;

FIG. 3 is a perspective view of a state in which joint pieces and cables are attached to the module plate according to the embodiment of the present invention;

FIG. 4 is a perspective view of a state in which a joint cover is attached to the joint pieces according to the embodiment of the present invention;

FIG. 5 is a partial cross-sectional view taken along line A-A of FIG. 4;

FIG. 6 is a front view of a state in which the seat cable module according to the embodiment of the present invention is attached to a seat; and

FIG. 7 is a front view of the packaging of the seat cable module according to the embodiment of the present invention.

### DESCRIPTION OF EMBODIMENTS

Hereinafter, an embodiment of the present disclosure will be described with reference to the drawings. Note that each of the embodiments described below shows a specific example of the present disclosure. Therefore, the constituent elements, the arrangement positions and connection forms of the constituent elements, and the like described in the following embodiments are merely examples, and are not intended to limit the present disclosure. Thus, among the constituent elements in the following embodiments, constituent elements not recited in the independent claim are described as arbitrary constituent elements.

Furthermore, the drawings are schematic diagrams, and are not necessarily illustrated in an exact manner. Note that, in the drawings, substantially the same components are denoted by the same reference numerals, and redundant descriptions thereof will be omitted or simplified.

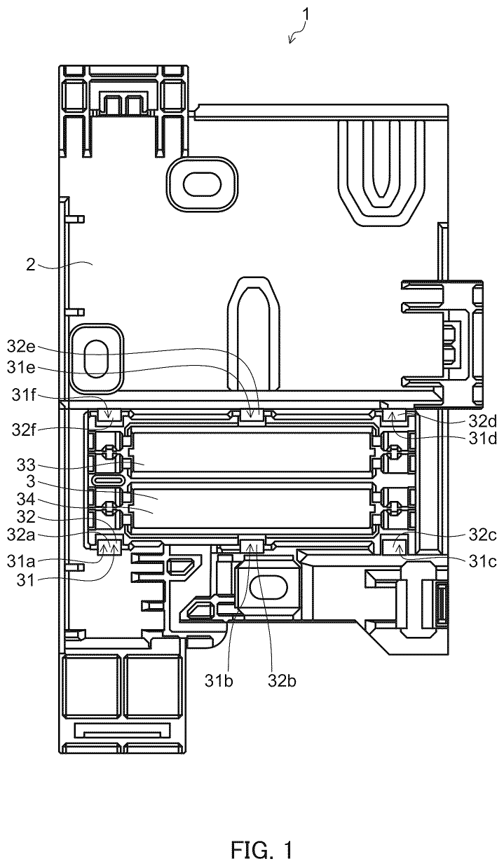

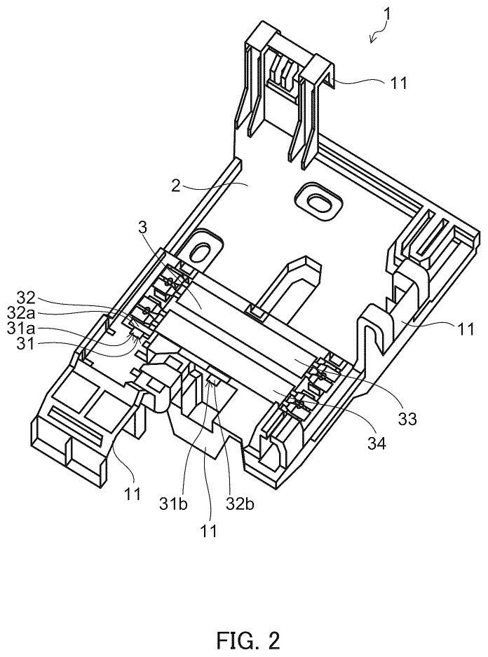

FIG. 1 is a front view of module plate 2 according to an embodiment of the present invention. FIG. 2 is a perspective view of module plate 2 according to the embodiment of the present invention. Seat cable module 1 according to the present embodiment is applied to, for example, a vehicle seat provided in a vehicle.

Seat cable module 1 includes module plate 2 and joint case 3. Cables 5 to be described later are placed on module plate 2, and module plate 2 is fixed to a pipe disposed in the vehicle seat.

Joint piece 4 to be described later and cables 5 (first cable, second cable) are attached to joint case 3, and joint case 3 is integrally molded with module plate 2. Joint case 3 includes claw holding portions 31 and housing portions 33 and 34.

Claw holding portions 31 (31a to 31f) are holding portions that respectively engage with claw portions 61 (61a to 61f) provided in joint cover 6 to be described later, and are formed at six positions on the periphery of joint case 3. Claw holding portions 31a, 31c, 31d, and 31f are respectively formed at four positions in the vicinity of the corners of joint case 3, and claw holding portions 31b and 31e are respectively formed at two positions in the vicinity of the central periphery of joint case 3.

Further, in claw holding portions 31, holes 32 (32a to 32f) penetrating joint case 3 are formed at six positions similarly to claw holding portions 31. Holes 32a to 32f are formed at the outer portions of claw holding portions 31, and claw portions 61a to 61f included in joint cover 6 are fixed to holes 32a to 32f.

Housing portions 33 and 34 are formed in the center of joint case 3, and joint pieces 4a and 4b are slidably housed therein.

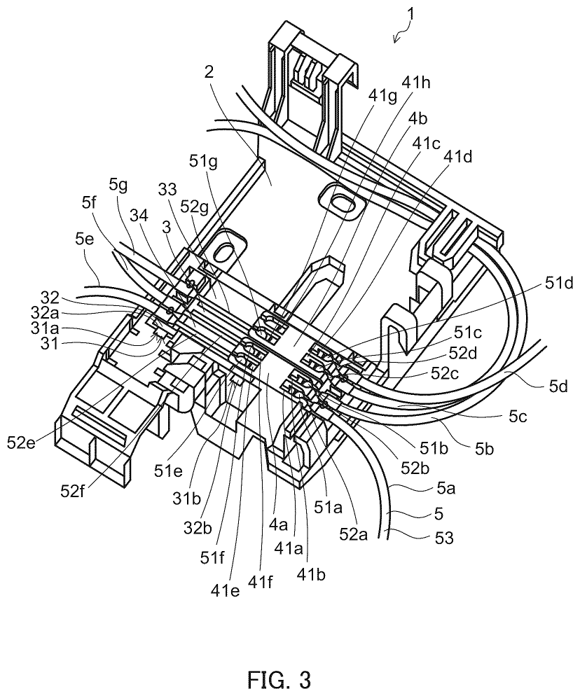

FIG. 3 is a perspective view of a state in which joint pieces 4a and 4b and cables 5 (5a to 5g) are attached to module plate 2 according to the embodiment of the present invention.

Seat cable module 1 includes cables 5a to 5g. Cables 5a to 5g each include inner cable 52 (52a to 52g) and outer casing 53 that slidably houses inner cable 52 inside to protect inner cable 52.

Seat cable module 1 operates a reclining mechanism of a vehicle seat and a locking mechanism for fixing the position of a seat surface by transmitting a tensile force with respect to inner cables 52a to 52d of cables 5a to 5d as first cables, for example, to inner cables 52e to 52g of cables 5e to 5g as second cables, for example.

Joint piece 4a fixes end portions 51a and 51b of inner cables 52a and 52b of cables 5a and 5b and end portions 51e and 51f of inner cables 52e and 52f of cables 5e and 5f, pulls inner cables 52e and 52f of cables 5e and 5f by moving by the tensile force with respect to inner cables 52a and 52b of cables 5a and 5b, and transmits the tensile force to inner cables 52e and 52f of cables 5e and 5f.

Joint piece 4b fixes end portions 51c and 51d of inner cables 52c and 52d of cables 5c and 5d and end portion 51g of inner cable 52g of cable 5g, pulls inner cable 52g of cable 5g by moving by the tensile force with respect to inner cables 52c and 52d of cables 5c and 5d, and transmits the tensile force to inner cable 52g of cable 5g.

Module plate 2 is provided with housing portions 33 and 34 for movably housing joint pieces 4a and 4b in a direction in which a tensile force is applied. Housing portions 33 and 34 open so as to be capable of housing joint pieces 4 in a direction perpendicular to the surface of module plate 2.

Joint pieces 4a and 4b each have a rectangular parallelepiped shape and are housed in housing portions 33 and 34 of joint case 3.

At each of the both ends of joint pieces 4a and 4b, two grooves 41 (41a to 41h) are formed. End portions 51a to 51g of the inner cables of cables 5a to 5g have spherical shapes and are inserted into grooves 41a to 41h. Thus, end portions 51a to 51g can remain fixed to grooves 41a to 41h even when cables 5a to 5g are pulled in a longitudinal direction of joint pieces 4a and 4b.

Note that grooves 41a and 41e and grooves 41b and 41f communicate with each other inside joint piece 4a in a sliding direction of joint piece 4a. Further, grooves 41c and 41g and grooves 41d and 41h communicate with each other inside joint piece 4b in a sliding direction of joint piece 4b.

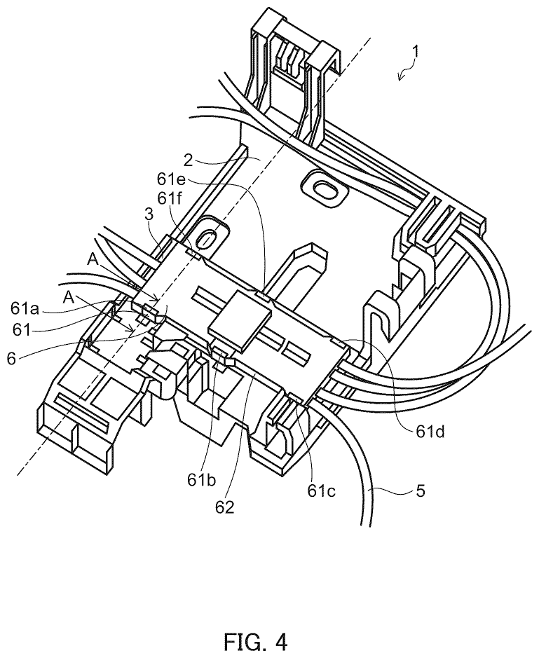

FIG. 4 is a perspective view of a state in which joint cover 6 is attached to joint pieces 4a and 4b according to the embodiment of the present invention. Joint cover 6 is disposed so as to cover joint pieces 4a and 4b housed in housing portions 33 and 34.

Joint cover 6 includes claw portions 61 (61a to 61f) that engage with module plate 2. Module plate 2 includes holes 32 into which claw portions 61 are inserted, as described above, and claw portions 61 engage with claw holding portions 31 of the side surface of holes 32. Six claw portions 61a to 61f are formed on two side surfaces 62 of joint cover 6 facing each other.

Claw portions 61 extend in a direction perpendicular to module plate 2 from side surfaces 62 of joint cover 6. Claw portions 61a to 61f respectively engage with claw holding portions 31a to 31f, and joint cover 6 is fixed to joint case 3 so as to cover housing portions 33 and 34 of joint case 3 and joint pieces 4a and 4b.

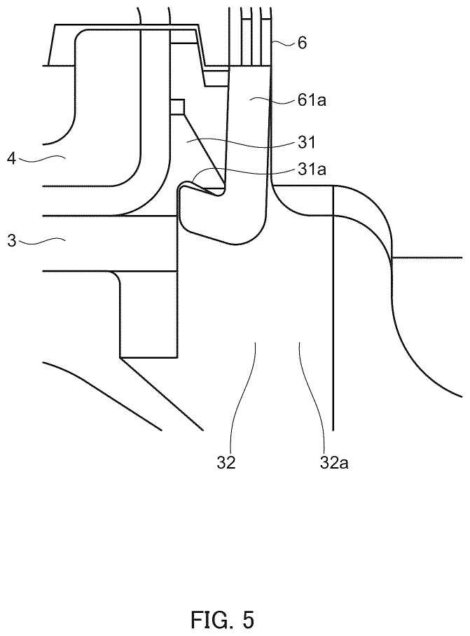

FIG. 5 is a partial cross-sectional view taken along line A-A of FIG. 4. The end of claw portion 61a is hook-shaped, and claw portion 61a is inserted into hole 32a formed in joint case 3. The engagement of claw portion 61a with the recessed portion formed in claw holding portion 31a firmly fixes joint cover 6 to joint case 3. The same applies to the engagements of other claw portions 61b to 61f with claw holding portions 31b to 31f.

Conventionally, joint case 3 is not integrally molded with module plate 2, and thus the conventional joint case has a bottom, which causes a problem of increasing the thickness. Joint case 3 in the present embodiment is integrally molded with module plate 2, and claw portion 61 of joint cover 6 can be fixed to claw holding portion 31 formed around holes 32, so that the thickness of joint cover 6 can be reduced.

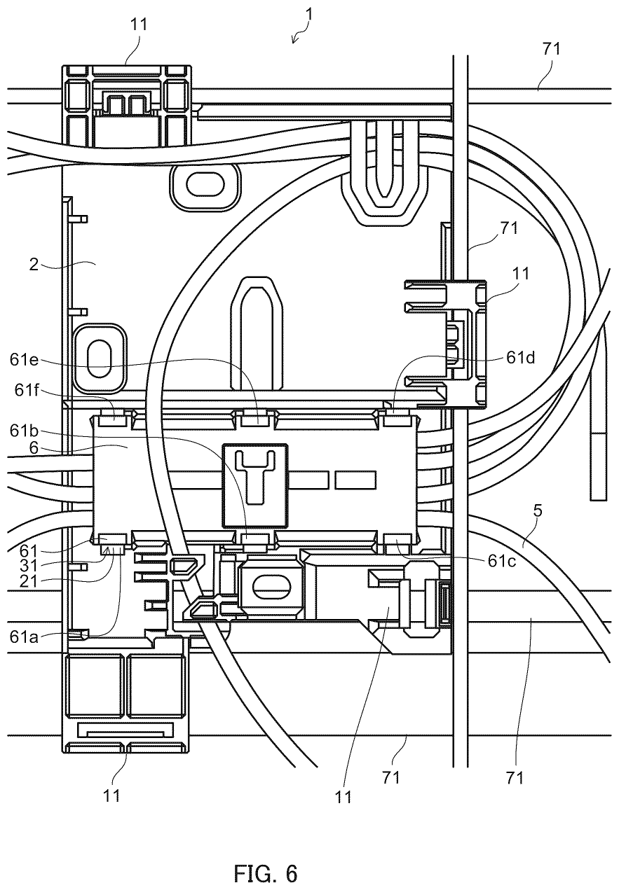

FIG. 6 is a front view of a state in which seat cable module 1 according to the embodiment of the present invention is attached to a vehicle seat. As illustrated in FIGS. 2 and 6, supporting portions 11 are formed at four positions in module plate 2 to fix seat cable module 1 to pipes 71 disposed in the seat. Supporting portions 11 are each formed in a hook-like shape, so that module plate 2 can be fixed to four pipes 71.

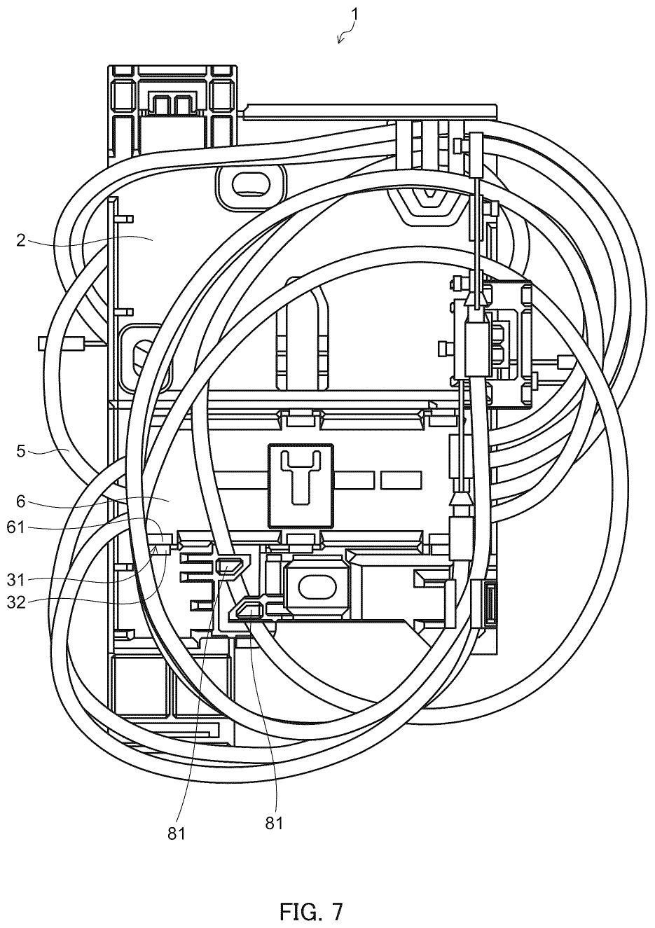

FIG. 7 is a front view of the packaging of seat cable module 1 according to the embodiment of the present invention. Seat cable module 1 is provided with fasteners 81 for fixing cable 5 at the time of shipment or the like.

In the conventional seat cable module, when attaching the joint case to the main body, it is necessary to laterally move the joint case from the central side of the main body and engage the joint case with the claw portion provided at the end portion of the main body.

In seat cable module 1 of the present embodiment, joint pieces 4a and 4b can be attached from a direction perpendicular to the surface of module plate 2, and joint pieces 4a and 4b need not be moved laterally to the end portion of the main body as in the conventional seat cable module, which makes it possible to provide fastener 81 at a position remote from the end portion of the main body.

Further, joint cover 6 has a lower height and is miniaturized, and thus cable 5 can be placed on the upper surface of joint cover 6. Therefore, cable 5 can be compactly bundled at the time of shipment or the like, and the size of the package of seat cable module 1 can be reduced.

Further, the conventional joint case is engaged with a claw portion provided at the end portion of the main body of the seat cable module, but the end portion of the main body has low strength and is easy to bend, which causes a problem in that the joint case comes off the claw portion provided at the end portion of the main body when a force is applied to the cable.

In seat cable module 1 of the present embodiment, joint cover 6 can be attached by claw portion 61 from a direction perpendicular to the surface of module plate 2, and the attachment point can be set at a position that has high strength and is remote from the end portion of the main body of seat cable module 1. Thus, it is possible to prevent joint cover 6 from coming off joint case 3 even when a force is applied to cable 5.

As described above, in seat cable module 1 of the present embodiment, housing portions 33 and 34 for joint pieces 4a and 4b open so as to be capable of housing joint pieces 4a and 4b in a direction perpendicular to the surface of module plate 2, and thus joint pieces 4a and 4b can be housed from the above instead of being laterally moved and housed, which eliminates the need to provide a space for the movement and can miniaturize seat cable module 1.

Note that, although seat cable module 1 includes joint cover 6 in the above-described embodiment, seat cable module 1 does not necessarily have to include joint cover 6.

For example, housing portions 33 and 34 may include two wall surfaces having inverted L-shapes, and the cross sections of the walls may hold parts of housed joint pieces 4a and 4b from the side surface to a part of the upper surface so that housed joint pieces 4a and 4b do not come off.

In the above-described embodiment, joint pieces 4a and 4b are provided, but only one joint piece may be provided. Further, in the above-described embodiment, a description has been given to a seat cable module that operates a reclining mechanism of a vehicle seat and a locking mechanism for fixing the position of a seat surface by transmitting a tensile force with respect to inner cables 52a to 52d of cables 5a to 5d to inner cables 52e to 52g of cables 5e to 5g, but the number of cables to be used can be appropriately set depending on the number of operation sections and working sections.

### INDUSTRIAL APPLICABILITY

The present invention can be widely used in seat cable modules.

### REFERENCE SIGNS LIST

1 Seat Cable Module
2 Module plate
3 Joint case
4 Joint piece
5 Cable
6 Joint cover
11 Supporting portion
31 Claw holding portion
32 Hole
33 Housing portion
41 Groove
51 End portion
52 Inner cable
61 Claw portion
71 Pipe
81 Fastener

1. A seat cable module for operating a seat by transmitting a tensile force with respect to a first cable to a second cable, the seat cable module comprising:
a joint piece that fixes an end portion of the first cable and an end portion of the second cable, pulls the second cable by moving by the tensile force, and transmits the tensile force to the second cable; and
a module plate in which a housing portion is formed, the housing portion movably housing the joint piece in a direction in which the tensile force acts, wherein
the housing portion opens so as to be capable of housing the joint piece in a direction perpendicular to a surface of the module plate.

2. The seat cable module according to claim 1, further comprising a cover that covers the joint piece housed in the housing portion, wherein
the cover includes a claw portion that engages with the module plate.

3. The seat cable module according to claim 2, wherein
the module plate includes a hole into which the claw portion is inserted, and the claw portion engages with a side surface of the hole.

4. The seat cable module according to claim 2, wherein
the claw portion is formed on two side surfaces of the cover, the two side surfaces facing each other.

5. The seat cable module according to claim 1, further comprising:
the first cable; and
the second cable.
